(19) United States
(12) Patent Application Publication
(10) Pub. No.: US 2025/0056568 A1
(43) Pub. Date: Feb. 13, 2025

(54) TECHNIQUES FOR DISCOVERING DEVICES THAT SUPPORT COOPERATION IN WIRELESS COMMUNICATIONS

(71) Applicant: QUALCOMM Incorporated, San Diego, CA (US)

(72) Inventors: Luanxia YANG, Beijing (CN); Aleksandar DAMNJANOVIC, Del Mar, CA (US); Jing SUN, San Diego, CA (US); Changlong XU, Beijing (CN); Xiaoxia ZHANG, San Diego, CA (US); Shaozhen GUO, Beijing (CN); Siyi CHEN, Beijing (CN)

(21) Appl. No.: 18/719,168

(22) PCT Filed: Feb. 26, 2022
(86) PCT No.: PCT/CN2022/078124

§ 371 Date: Jun. 12, 2024

(51) Int. Cl. H04W 72/25; H04W 40/24

(52) U.S. Cl. CPC H04W 72/25; H04W 40/24

(57) ABSTRACT

Some aspects described herein relate to transmitting, by a first user equipment (UE), a cooperation discovery signal related to cooperative communication, and receiving, from one or more second UEs and in response to the cooperation discovery signal, a request to connect with the first UE for cooperative communication. Other aspects relate to receiving the cooperation discovery signal and transmitting the request in response to the cooperation discovery signal.

### BACKGROUND

Aspects of the present disclosure relate generally to wireless communication systems, and more particularly, to cooperative transmission/reception among devices.

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable low-latency communications (URLLC) with certain specifications for latency and reliability; and massive machine type communications, which can allow a very large number of connected devices and transmission of a relatively low volume of non-delay-sensitive information. As the demand for mobile broadband access continues to increase, however, further improvements in 5G communications technology and beyond may be desired.

Devices that can communicate using 5G NR, or other wireless technologies, such as user equipment (UEs) may have baseband modem processing capabilities with higher performance than radio frequency (RF) capabilities, resulting in RF capabilities possibly limiting user experience while baseband processing capabilities may be underutilized.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, a first user equipment (UE) for wireless communication is provided that includes a transceiver, a memory configured to store instructions, and one or more processors communicatively coupled with the memory and the transceiver. The one or more processors are configured to transmit a cooperation discovery signal related to cooperative communication, and receiving, from one or more second UEs and in response to the cooperation discovery signal, a request to connect with the first UE for cooperative communication.

In another aspect, a first UE for wireless communication is provided that includes a transceiver, a memory configured to store instructions, and one or more processors communicatively coupled with the memory and the transceiver. The one or more processors are configured to receive, from a second UE, a cooperation discovery signal related to cooperative communication, and transmit, in response to the cooperation discovery signal, a request to connect with the second UE for cooperative communication.

In another aspect, a method for wireless communication is provided that includes transmitting, by a first UE, a cooperation discovery signal related to cooperative communication, and receiving, from one or more second UEs and in response to the cooperation discovery signal, a request to connect with the first UE for cooperative communication.

In another aspect, a method for wireless communication is provided that includes receiving, from a first UE, a cooperation discovery signal related to cooperative communication, and transmitting, by a second UE and in response to the cooperation discovery signal, a request to connect with the first UE for cooperative communication.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a diagram illustrating an example of disaggregated base station architecture, in accordance with various aspects of the present disclosure;

FIG. 3 is a block diagram illustrating an example of a user equipment (UE), in accordance with various aspects of the present disclosure;

FIG. 4 is a block diagram illustrating an example of a base station, in accordance with various aspects of the present disclosure;

FIG. 5 is a flow chart illustrating an example of a method for transmitting cooperation discovery signals, in accordance with various aspects of the present disclosure;

FIG. 6 is a flow chart illustrating an example of a method for receiving cooperation discovery signals, in accordance with various aspects of the present disclosure;

FIG. 7 is a flow chart illustrating an example of a method for configuring resources for cooperation discovery signals, in accordance with various aspects of the present disclosure;

FIG. 8 illustrates an example of a call flow of communications between a transmitting (Tx) UE, a receiving (Rx) UE, and/or a network node; and

FIG. 9 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to communicating discovery signals to indicate a device (e.g., user equipment (UE)) capability or request for cooperative transmission or reception. As the UE may have baseband processing capabilities that have higher performance than its radio frequency (RF) capabilities, for example, the UE can cooperate with otherwise idle UEs to leverage the RF capabilities of the otherwise idle UEs for improved RF throughput, where the baseband capabilities of the UE can adequately handle the additional RF throughput. Aggregation through cooperation of neighboring cooperative, otherwise idle UEs, can be exploited to improve target UE. For example, user experience can be improved through increased throughput and quality of service, link diversity can address blockage issues, link budget can be improved, which can be particularly important for reduced capability devices, etc. In addition, overall system capacity can be increased if system capacity is limited by RF capabilities of active UEs in the cell. For example, where a gNB has 64 antennas and a UE has 4 antennas, there can be a 64×4 link using a single UE. Where the UE can leverage RF resources of another UE, a 64×8 link may be achieved, for example.

For example, cooperation via user virtualization can be applied in certain scenarios, applications, and evaluations. In an example, cooperative transmission/reception schemes can include coherent/non-coherent transmission, diversity based transmission, or soft combining, device/antenna group selection, multi-layer/carrier transmission/reception, etc. In one example, users can be grouped and/or groups can be maintained based on considering adaptive number of antennas/carriers, control/data plane, etc. Enhancements can be made on mobility measurements and events, for example, for forming a virtual user. Sidelink support for cooperative transmission/reception can include timing and resource allocation, in an example.

Various aspects described herein relate to enabling a UE to initiate cooperation with one or more other UEs (e.g., either as the target UE or the cooperative UE) without requiring control of a base station or other access point. In an aspect, the target UE can be defined as the UE receiving cooperation from one or more cooperative UEs, and the cooperative UE can be defined as the UE providing cooperation to the target UE. In one example, the target UE can receive communications from a base station via the one or more cooperative UEs, where the one or more cooperative UEs receive the communications from the base station via RF resources and provide the communications to the target UE for baseband processing. In another example, the target UE can transmit communications to the base station via the one or more cooperative UEs, where the one or more cooperative UEs receive the communications from the target UE and transmit the communications to the base station via RF resources.

In accordance with aspects described herein, the UE transmitting the discovery signal can be the target UE and/or cooperative UE. This UE can determine the system parameters to be broadcasted to other UEs that may join the cooperation. The UE can determine the same system parameters for the UEs (e.g., in an Internet-of-things (IoT) deployment) or use different parameters across different UEs. Aspects described herein relate to providing a mechanism to broadcast the parameters, requirements, and/or the like, for UE cooperation, and/or a mechanism for another UE to find the UE cooperation parameters, requirements, and/or the like.

For example, enabling the UEs to transmit discovery signals for cooperation may allow the UEs to discover one another for the purpose of cooperation without requiring the base station to assist. This can expedite setup of cooperation between the UEs by not requiring traversal of, or coordination from, another node. In some aspects, mechanisms already defined in a wireless communication technology, such as sidelink discovery signaling in 5G NR, can be used or reused for cooperation discovery as well, which can mitigate the need for additional signaling, thus conserving radio resources and power consumption of the UEs. Reducing processing and power consumption, in this regard, can improve UE performance and user experience.

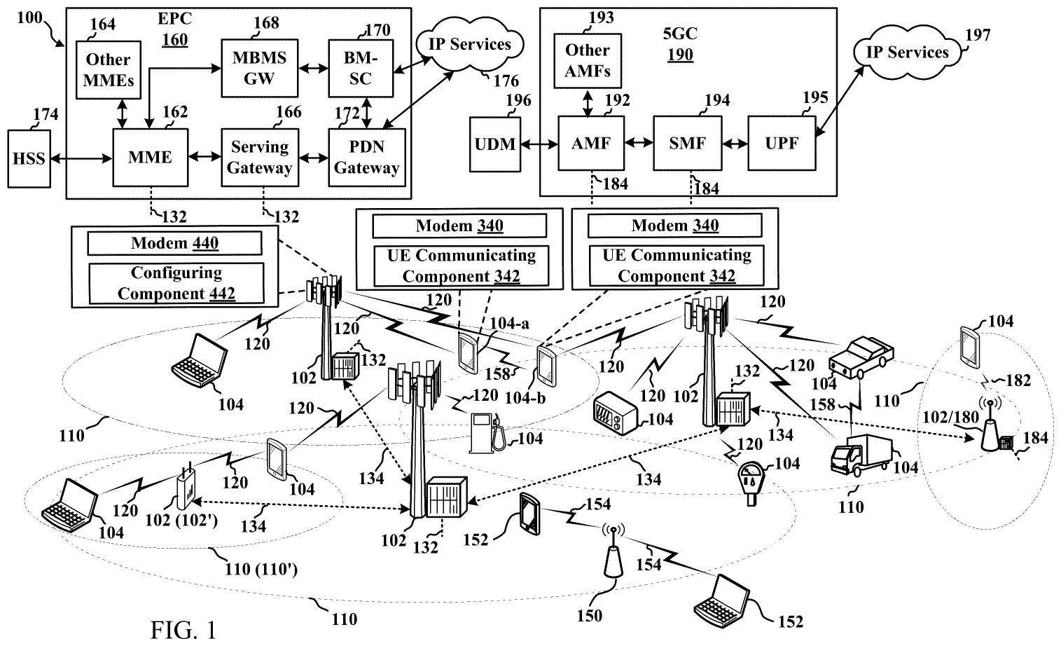

The described features will be presented in more detail below with reference to FIGS. 1-9.

As used in this application, the terms “component,” “module,” “system” and the like are intended to include a computer-related entity, such as but not limited to hardware, software, a combination of hardware and software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Techniques described herein may be used for various wireless communication systems such as CDMA, TDMA, FDMA, OFDMA, SC-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 340 and a UE communicating component 342 for communicating cooperation discovery signals and/or establishing cooperation, as described further herein. In addition, some nodes may have a modem 440 and configuring component 442 for configuring UEs to communicate cooperation discovery signals, as described herein. Though UE 104-a and UE 104-b are shown as having the modem 340 and UE communicating component 342 and a base station 102 is shown as having the modem 440 and configuring component 442, this is one illustrative example, and substantially any node or type of node may include a modem 340 and UE communicating component 342, and/or a modem 440 and configuring component 442 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs (e.g., UE 104-a and 104-b) may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network. In addition, in this regard, UEs 104-a, 104-b can use a portion of frequency in the 5 GHz unlicensed frequency spectrum in communicating with the small cell 102′, with other cells, with one another using sidelink communications, etc. The UEs 104-a, 104-b, small cell 102′, other cells, etc. can use other unlicensed frequency spectrums as well, such as a portion of frequency in the 60 GHz unlicensed frequency spectrum.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a positioning system (e.g., satellite, terrestrial), a multimedia device, a video device, a digital audio player (e.g., MP3 player), a camera, a game console, a tablet, a smart device, robots, drones, an industrial/manufacturing device, a wearable device (e.g., a smart watch, smart clothing, smart glasses, virtual reality goggles, a smart wristband, smart jewelry (e.g., a smart ring, a smart bracelet)), a vehicle/a vehicular device, a meter (e.g., parking meter, electric meter, gas meter, water meter, flow meter), a gas pump, a large or small kitchen appliance, a medical/healthcare device, an implant, a sensor/actuator, a display, or any other similar functioning device. Some of the UEs 104 may be referred to as IoT devices (e.g., meters, pumps, monitors, cameras, industrial/manufacturing devices, appliances, vehicles, robots, drones, etc.). IoT UEs may include machine type communications (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In an example, in a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.), including base station 102 described above and further herein, may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as virtually distributing functionality for at least one unit, which can enable flexibility in network design. The various units of the disaggregated base station, or disaggregated RAN architecture, can be configured for wired or wireless communication with at least one other unit.

In an example, UE communicating component 342 of a first UE (e.g., UE 104-a) can transmit a cooperation discovery signal as one of a target UE to request cooperation from one or more other UEs or a cooperative UE to advertise cooperation capability for one or more other UEs. In an example, UE communicating component 342 of a second UE (e.g., UE 104-b) can receive and process the cooperation discovery signal and can one of establish cooperation for the target UE or establish a connection with the target UE to receive cooperation, etc., as described further herein. The cooperation discovery signal may include parameters related to providing cooperation to the UE 104-a, receiving cooperation from the UE 104-a, establishing a connection with the UE 104-a for receiving or providing cooperation, etc.

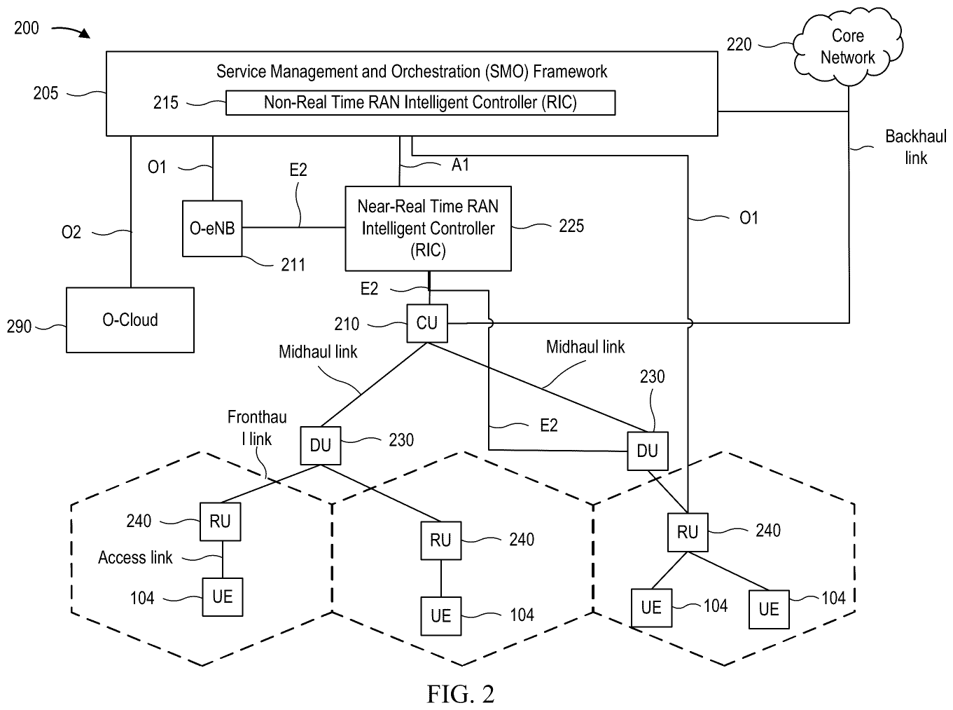

FIG. 2 shows a diagram illustrating an example of disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance.

For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

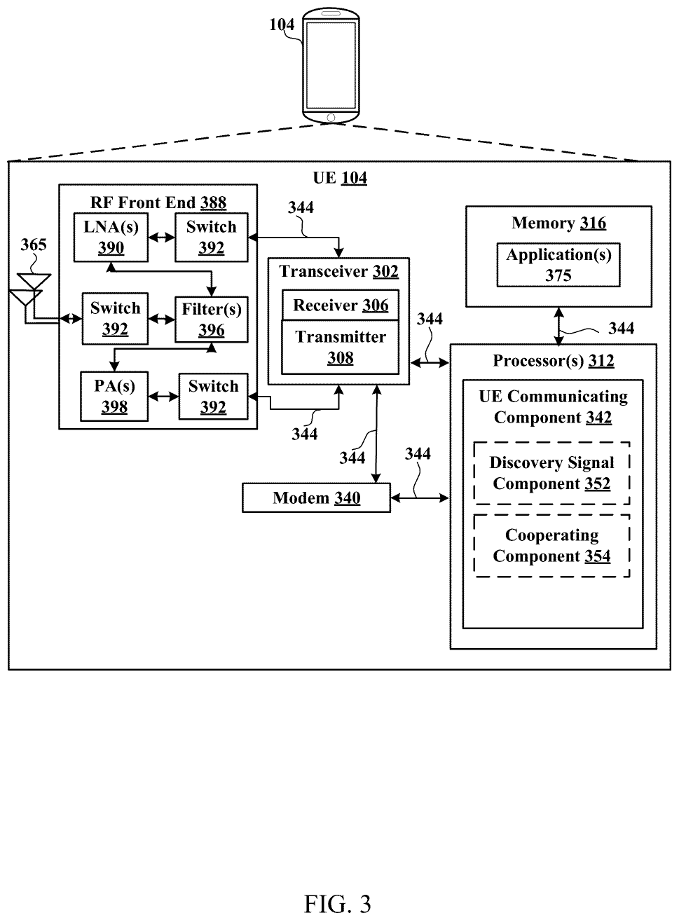

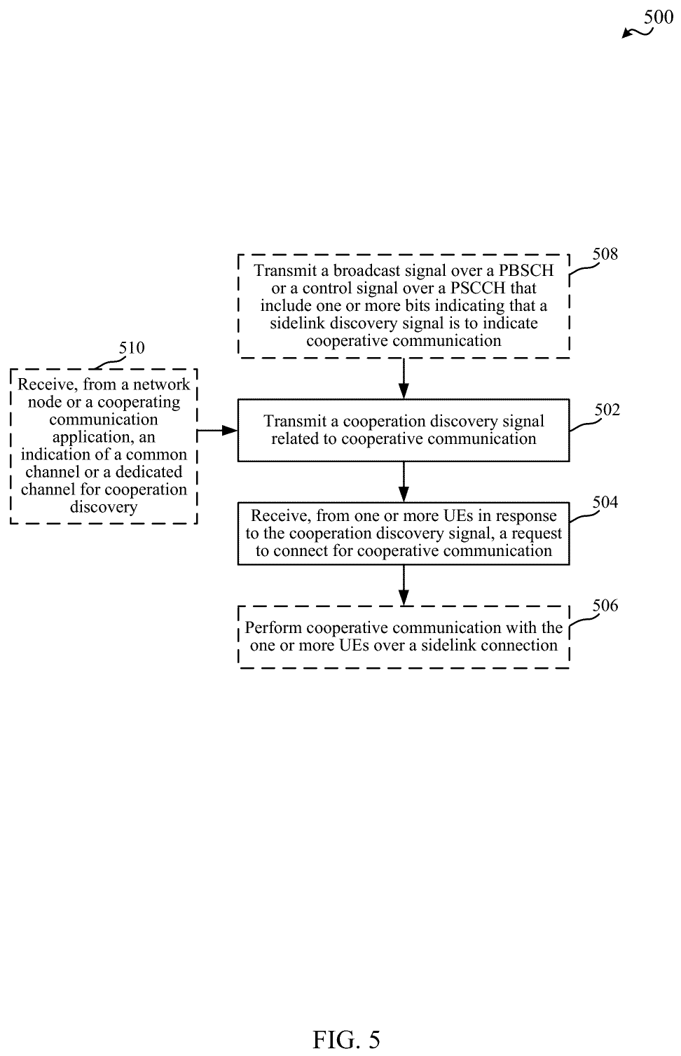

Turning now to FIGS. 3-9, aspects are depicted with reference to one or more components and one or more methods that may perform the actions or operations described herein, where aspects in dashed line may be optional. Although the operations described below in FIGS. 5-8 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 3, one example of an implementation of UE 104 may include a variety of components, some of which have already been described above and are described further herein, including components such as one or more processors 312 and memory 316 and transceiver 302 in communication via one or more buses 344, which may operate in conjunction with modem 340 and/or UE communicating component 342 for communicating cooperation discovery signals and/or establishing cooperation, as described herein.

In an aspect, the one or more processors 312 can include a modem 340 and/or can be part of the modem 340 that uses one or more modem processors. Thus, the various functions related to UE communicating component 342 may be included in modem 340 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 340 associated with UE communicating component 342 may be performed by transceiver 302.

Also, memory 316 may be configured to store data used herein and/or local versions of applications 375 or UE communicating component 342 and/or one or more of its subcomponents being executed by at least one processor 312. Memory 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory 316 may be a non-transitory computer-readable storage medium that stores one or more computer-executable codes defining UE communicating component 342 and/or one or more of its subcomponents, and/or data associated therewith, when UE 104 is operating at least one processor 312 to execute UE communicating component 342 and/or one or more of its subcomponents.

Transceiver 302 may include at least one receiver 306 and at least one transmitter 308. Receiver 306 may include hardware and/or software executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one base station 102 or a SL transmitting UE. Additionally, receiver 306 may process such received signals, and also may obtain measurements of the signals, such as, but not limited to, Ec/Io, signal-to-noise ratio (SNR), reference signal received power (RSRP), received signal strength indicator (RSSI), etc. Transmitter 308 may include hardware and/or software executable by a processor for transmitting data, the code comprising instructions and being stored in a memory (e.g., computer-readable medium). A suitable example of transmitter 308 may including, but is not limited to, an RF transmitter.

Moreover, in an aspect, UE 104 may include RF front end 388, which may operate in communication with one or more antennas 365 and transceiver 302 for receiving and transmitting radio transmissions, for example, receiving wireless communications transmitted by at least one base station 102 or a SL transmitting UE, transmitting wireless communications to at least one base station 102 or a SL receiving UE, etc. RF front end 388 may be connected to one or more antennas 365 and can include one or more low-noise amplifiers (LNAs) 390, one or more switches 392, one or more power amplifiers (PAs) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that UE 104 can communicate with, for example, one or more base stations 102 or one or more cells associated with one or more base stations 102, one or more other UEs in SL communications, etc. In an aspect, for example, modem 340 can configure transceiver 302 to operate at a specified frequency and power level based on the UE configuration of the UE 104 and the communication protocol used by modem 340.

In an aspect, modem 340 can be a multiband-multimode modem, which can process digital data and communicate with transceiver 302 such that the digital data is sent and received using transceiver 302. In an aspect, modem 340 can be multiband and be configured to support multiple frequency bands for a specific communications protocol. In an aspect, modem 340 can be multimode and be configured to support multiple operating networks and communications protocols. In an aspect, modem 340 can control one or more components of UE 104 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, UE communicating component 342 can optionally include a discovery signal component 352 for communicating (e.g., transmitting or receiving) cooperation discovery signals to discover UEs for cooperation, and/or a cooperating component 354 for establishing cooperation with one or more UEs, as described further herein.

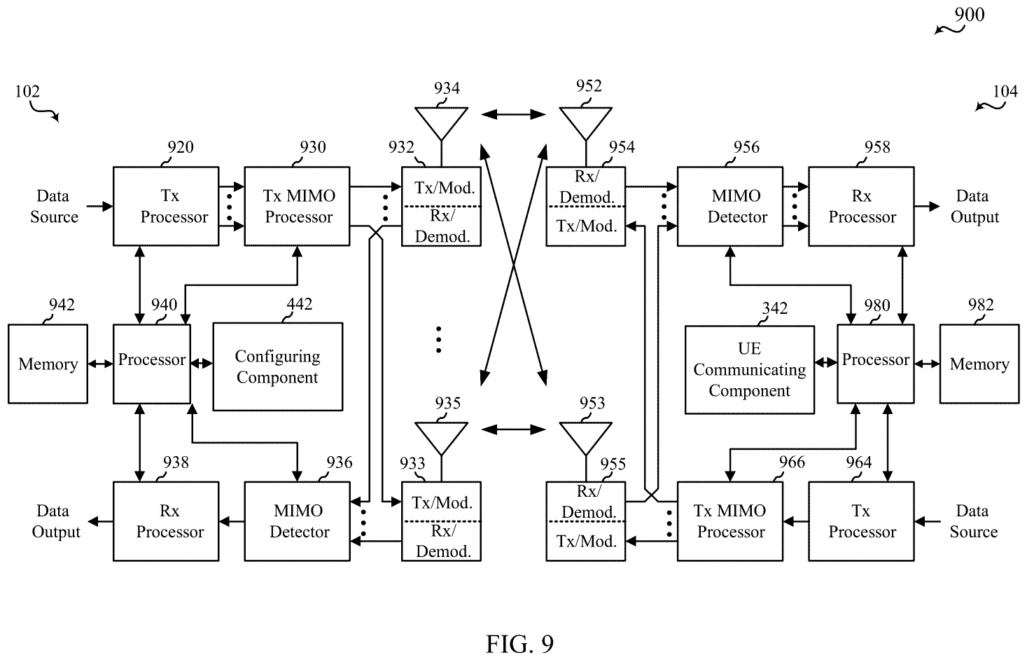

In an aspect, the processor(s) 312 may correspond to one or more of the processors described in connection with the UE in FIG. 9. Similarly, the memory 316 may correspond to the memory described in connection with the UE in FIG. 9.

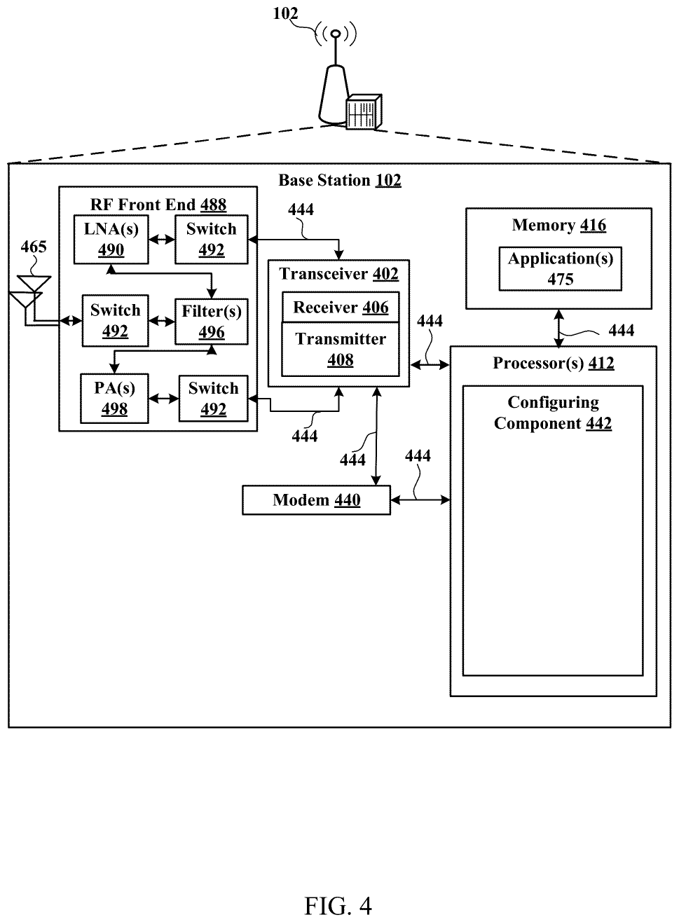

Referring to FIG. 4, one example of an implementation of base station 102 (e.g., a base station 102 and/or gNB 180, as described above), which may include a monolithic base station, disaggregated base station, or other network node, may include a variety of components, some of which have already been described above, but including components such as one or more processors 412 and memory 416 and transceiver 402 in communication via one or more buses 444, which may operate in conjunction with modem 440 and configuring component 442 for configuring UEs for communicating cooperation discovery signals, as described herein.

The transceiver 402, receiver 406, transmitter 408, one or more processors 412, memory 416, applications 475, buses 444, RF front end 488, LNAs 490, switches 492, filters 496, PAs 498, and one or more antennas 465 may be the same as or similar to the corresponding components of UE 104, as described above, but configured or otherwise programmed for base station operations as opposed to UE operations.

In an aspect, the processor(s) 412 may correspond to one or more of the processors described in connection with the base station in FIG. 9. Similarly, the memory 416 may correspond to the memory described in connection with the base station in FIG. 9.

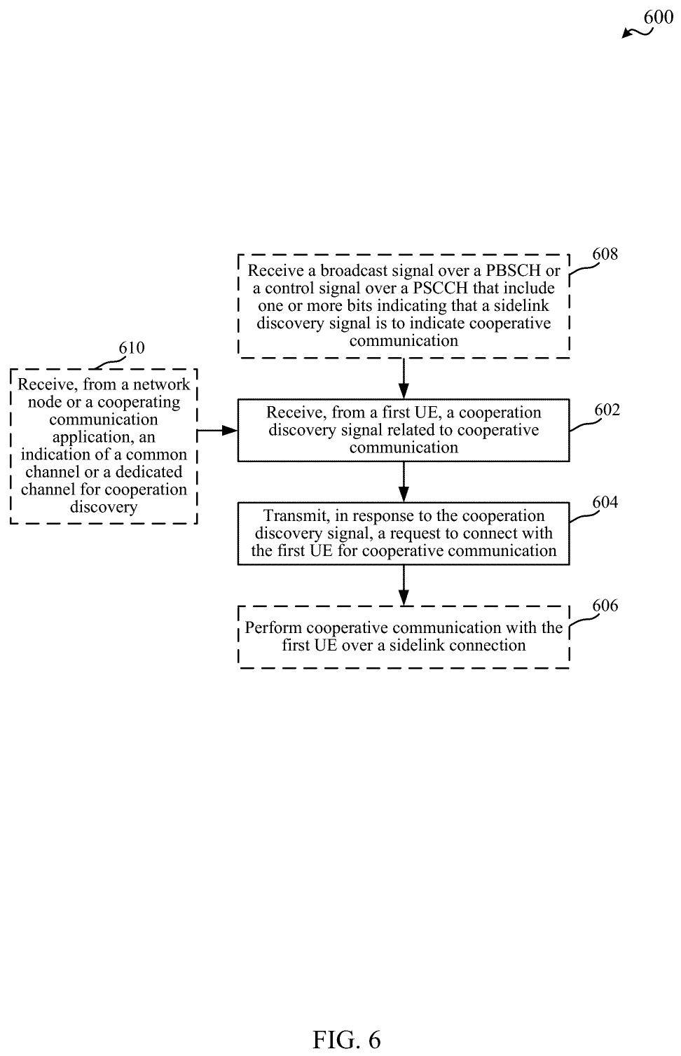

FIG. 5 illustrates a flow chart of an example of a method 500 for transmitting cooperation discovery signals. FIG. 6 illustrates a flow chart of an example of a method 600 for receiving cooperation discovery signals. In an example, a Tx UE (e.g., UE 104-a) can perform the functions described in method 500 using one or more of the components described in FIGS. 1 and 3. In an example, a Rx UE (e.g., 104-b) can perform the functions described in method 600 using one or more of the components described in FIGS. 1 and 3. A Tx UE is referred to herein as the UE initially transmitting the cooperation discovery signal, though the Tx UE can also receive communications from another UE. Similarly, a Rx UE is referred to herein as the UE initially receiving the cooperation discovery signal, though the Rx UE can also transmit communications to another UE. Though described in conjunction with one another for ease of explanation, methods 500 and 600 are not required to be performed together and may be performed independently (on distinct devices or otherwise). Moreover, in some examples, a given UE 104 may be configured to perform one or both of methods 500 and/or 600 in a given scenario.

In method 500, at Block 502, a cooperation discovery signal related to cooperative communication can be transmitted. In an aspect, discovery signal component 352, e.g., in conjunction with processor(s) 312, memory 316, transceiver 302, UE communicating component 342, etc., of a transmitting (Tx) UE 104-a, can transmit the cooperation discovery signal related to cooperative communication. For example, the cooperation discovery signal can indicate that the Tx UE 104-a supports cooperative communication, as a target UE or a cooperative UE, such that the Tx UE 104-a can utilize RF resources shared by one or more other UEs or can share its own RF resources with one or more other UEs.

In method 600, at Block 602, a cooperation discovery signal related to cooperative communication can be received. In an aspect, discovery signal component 352, e.g., in conjunction with processor(s) 312, memory 316, transceiver 302, UE communicating component 342, etc., of a receiving (Rx) UE 104-b, can receive (e.g., from a Tx UE 104-a) the cooperation discovery signal related to cooperative communication. For example, the cooperation discovery signal can indicate that the Tx UE 104-a supports cooperative communication, as a target UE or a cooperative UE, such that the Tx UE 104-a can utilize RF resources shared by one or more other UEs or can share its own RF resources with one or more other UEs. In an example, based on receiving the cooperation discovery signal and/or based on one or more parameters in the cooperation discovery signal, the Rx UE 104-b may provide cooperative communication to the Tx UE 104-a or may establish a connection with the Tx UE 104-a to receive cooperative communication from the Tx UE 104-a.

In method 600, at Block 604, a request to connect with the first UE for cooperative communication can be transmitted in response to the cooperation discovery signal. In an aspect, cooperating component 354, e.g., in conjunction with processor(s) 312, memory 316, transceiver 302, UE communicating component 342, etc., of a Rx UE 104-b, can transmit (e.g., to a Tx UE 104-a), in response to cooperation discovery signal, the request to connect with the first UE for cooperative communication, or can otherwise provide cooperative communication to the first UE (e.g., the Tx UE 104-a). For example, cooperating component 354 can transmit a request to the first UE to establish a sidelink connection to facilitate communicating data for cooperative communication. In one example, the cooperation discovery signal may include one or more parameters for requesting to connect with the first UE, such as resources over which to send the request, and cooperating component 354 can send the request over the indicated resources.

In method 500, at Block 504, a request to connect for cooperative communication can be received from one or more UEs in response to the cooperation discovery signal. In an aspect, cooperating component 354, e.g., in conjunction with processor(s) 312, memory 316, transceiver 302, UE communicating component 342, etc., of a Tx UE 104-a, can receive, from one or more UEs (e.g., a Rx UE 104-b) in response to cooperation discovery signal, the request to connect for cooperative communication. For example, cooperating component 354 can receive the request to establish a sidelink connection to facilitate communicating data for cooperative communication. In one example, the cooperation discovery signal may include one or more parameters for requesting to connect with the first UE, such as resources over which to send the request, and cooperating component 354 can receive the request (and/or multiple requests from multiple UEs) over the indicated resources.

In method 500, optionally at Block 506, cooperative communication can be performed with the one or more UEs over the sidelink connection. In an aspect, cooperating component 354, e.g., in conjunction with processor(s) 312, memory 316, transceiver 302, UE communicating component 342, etc., of the Tx UE 104-a, can perform cooperative communication with the one or more UEs (e.g., the Rx UE 104-b) over the sidelink channel. For example, cooperating component 354 of the Tx UE 104-a can establish the sidelink channel with the one or more UEs (e.g., the Rx UE 104-b) based on the request. Accordingly, in an example, where the Tx UE 104-a is the target UE, cooperating component 354 of the Tx UE 104-a can transmit communications, which have been baseband processed, to the one or more Rx UEs 104-b over the sidelink channel to be transmitted by the one or more Rx UEs 104-b to a network node. Similarly, in an example, where the Tx UE 104-a is the target UE, cooperating component 354 of the Tx UE 104-a can receive communications, intended for the Tx UE 104-a and originating from the network node, from the one or more Rx UEs 104-b over the sidelink channel. In this example, the Tx UE 104-a may provide the communications to baseband processing resources for decoding the communications (e.g., along with other communications received by the Tx UE 104-a from the network node). In another example, where the Tx UE 104-a is the cooperative UE, cooperating component 354 of the Tx UE 104-a can receive communications, intended for the one or more Rx UEs 104-b, from the network node, and can transmit the communications to the one or more Rx UEs 104-b over the sidelink channel (e.g., without baseband processing the communications at the one or more Rx UEs 104-b). Similarly, in this example where the Tx UE 104-a is the cooperative UE, cooperating component of the Tx UE 104-a can receive baseband processed communications from the one or more Rx UEs 104-b over the sidelink channel, and can transmit the communications to the network node using RF resources of the Tx UE 104-a.

In method 600, optionally at Block 606, cooperative communication can be performed with the first UE over the sidelink connection. In an aspect, cooperating component 354, e.g., in conjunction with processor(s) 312, memory 316, transceiver 302, UE communicating component 342, etc., of the Rx UE 104-b, can perform cooperative communication with the first UE (e.g., the Tx UE 104-a) over the sidelink channel. For example, cooperating component 354 of the Rx UE 104-a can establish the sidelink channel with the first UE (e.g., the Tx UE 104-a) based on the request. Accordingly, in an example, where the Rx UE 104-b is the cooperative UE, cooperating component 354 of the Rx UE 104-b can receive communications, which have been baseband processed by the Tx UE 104-a, over the sidelink channel to be transmitted by the one or more Rx UEs 104-b to a network node. Similarly, in an example, where the Rx UE 104-b is the cooperative UE, cooperating component 354 of the Rx UE 104-b can receive communications from the network node that are intended for the Tx UE 104-a, and can transmit the communications to the Tx UE 104-a over the sidelink channel (e.g., without baseband processing the communications). In another example, where the Rx UE 104-b is the target UE, cooperating component 354 of the Rx UE 104-b can transmit baseband processed communications to the Tx UE 104-a over the sidelink channel for transmitting to the network node. Similarly, in this example where the Rx UE 104-b is the target UE, cooperating component of the Rx UE 104-b can receive communications from the Tx UE 104-a over the sidelink channel, where the communications are intended for the Rx UE 104-b and originate from the network node. In this example, the Rx UE 104-b may provide the communications to baseband processing resources for decoding the communications (e.g., along with other communications received by the Rx UE 104-b from the network node).

In one example, the cooperation discovery signal (e.g., transmitted by the discovery signal component 352 of the Tx UE 104-a and/or received by the discovery signal component 352 of the Rx UE 104-b) can be or include a sidelink discovery signal, e.g., as defined in 5G NR or similar wireless communication technologies. For example, the sidelink discovery signal can be transmitted by a first UE to allow nearby UEs to discover the first UE for sidelink communications. In an example, this sidelink discover signal can be repurposed or otherwise used as a cooperation discover signal to indicate cooperative communication functionality for the transmitting UE. In one example, one bit (or more than one bit) can be added to the sidelink discovery signal to indicate whether the sidelink discovery signal is for (additionally or alternatively) indicating cooperative communication capability or not. In one example, where the bit is set, the contents of the discovery signal may include parameters for cooperative communication. In another example, where the bit is not set, the contents of the discovery signal may include parameters for sidelink communications.

In another example, bits in a broadcast channel transmission can be used to indicate whether a discovery signal is for cooperative communication. For example, UE communicating component 342 of the Tx UE 104-a can transmit a broadcast channel transmission, such as a physical sidelink broadcast channel (PBSCH) transmission, that includes one or more reserved bits, which can be used to indicate whether the discovery signal is for cooperative communication or not. For example, the one or more reserved bits can be part of a master information block (MIB) transmitted by the Tx UE 104-a over PBSCH. For example, UE communicating component 342 of the Rx UE 104-b can receive a MIB over PBSCH (or other broadcast channel transmission) and can determine, based on the one or more reserved bits, whether the discovery signal is for cooperative communication. If the one or more reserved bits indicate that the sidelink discovery signal is for cooperative communication, discovery signal component 352 of the Tx UE 104-a can transmit, and/or discovery signal component 352 of the Rx UE 104-b can receive, the discovery signal as indicating one or more parameters for cooperative communication, as described further herein.

In another example, a control channel transmission for discovery signals can be used to indicate whether a discovery signal is for cooperative communication. For example, UE communicating component 342 of the Tx UE 104-a can transmit a discovery signal control channel transmission, such as a discovery signal (DS)-PSCCH transmission, that schedules the PSSCH that carries the discovery signal. For example, the DS-PSCCH can include a bit to indicate whether the scheduled discovery signal is for cooperative communication or not. If the bit indicates that the sidelink discovery signal is for cooperative communication, discovery signal component 352 of the Tx UE 104-a can transmit, and/or discovery signal component 352 of the Rx UE 104-b can receive, the discovery signal in the PSSCH and as indicating one or more parameters for cooperative communication, as described further herein.

In method 500, optionally at Block 508, a broadcast signal can be transmitted over a PBSCH, or a control signal over a PSSCH, that include one or more its indicating that a sidelink discovery signal is to indicate cooperative communication. In an aspect, discovery signal component 352, e.g., in conjunction with processor(s) 312, memory 316, transceiver 302, UE communicating component 342, etc., of the Tx UE 104-a, can transmit the broadcast signal over the PBSCH (e.g., a MIB) or the control signal over the PSSCH that include one or more bits indicating that the sidelink discovery signal is to indicate cooperative communication. In this regard, for example, discovery signal component 352 can transmit the cooperation discovery signal as the sidelink discovery signal indicating cooperative communication parameters.

In method 600, optionally at Block 608, a broadcast signal can be received over a PBSCH, or a control signal over a PSSCH, that include one or more its indicating that a sidelink discovery signal is to indicate cooperative communication. In an aspect, discovery signal component 352, e.g., in conjunction with processor(s) 312, memory 316, transceiver 302, UE communicating component 342, etc., of the Rx UE 104-b, can receive (e.g., from the Tx UE 104-a) the broadcast signal over the PBSCH (e.g., a MIB) or the control signal over the PSSCH that include one or more bits indicating that the sidelink discovery signal is to indicate cooperative communication. In this regard, for example, discovery signal component 352 can receive the cooperation discovery signal as the sidelink discovery signal indicating cooperative communication parameters, and cooperating component 354 can accordingly process the cooperative communication parameters in the discovery signal, as described further herein.

In another example, the cooperation discovery signal can be transmitted over a common channel, which may be transmitted in an unlicensed band (e.g., a common channel in NR or NR-unlicensed (NR-U)), for UE cooperation discovery. In these examples, more than one unlicensed channel can be assigned for UE cooperation discovery. For example, the common channel can be common for all cooperative UE (e.g., open discovery), where any UE can transmit a cooperation discovery signal over the common channel. In another example, the common channel may be defined for a specified group of cooperative UEs (e.g., closed discovery), where certain UEs in the group of cooperative UEs can transmit the cooperation discovery signal over the common channel. In this example, using a common channel can reduce the search range for UE cooperation, but may not limit other UEs to not use the channel for other transmission. In one specific example, a bandwidth unit of the channel can be 20 MHz.

In one example, a network node (e.g., a base station 102, such as a gNB, or a disaggregated component thereof, such as a CU, DU, or RU) can define a common channel or resource for UE cooperation or corresponding cooperation discovery signals. In this example, as described, the Tx UE 104-a transmitting the cooperation discovery signal over the common channel can be a target UE transmitting the signal to discover one or more cooperative UEs, or may be a cooperative UE transmitting the signal to discover one or more target UEs. For open discovery, in one example, the common channel or corresponding resources can be defined (e.g., in a wireless communication technology standard or otherwise known or programmed into a memory of the UEs 104-a, 104-b, and/or the network node). In another example, for open discovery, the network node can broadcast the resource information for the common channel in system information (e.g., in system information block (SIB) transmitted over physical broadcast channel (PBCH), etc.). For closed discovery, in an example, the network node can transmit the assigned resource information through paging message. In this example, each UE can be assigned one or multiple common channel resources for transmitting or receiving cooperation discovery signals. In this example, Tx UE 104-a can receive the paging message from the network node, determine the associated common channel resources, and transmit a cooperation discovery signal over the common channel resources. Similarly, in this example, Rx UE 104-a can receive the paging message from the network node, determine the associated common channel resources, and receive a cooperation discovery signal over the common channel resources.

In yet another example, a UE cooperation application executing on the UE can specify the common channel resources. For example, for open discovery, the application can select the discovery channel from the common channel resources. For closed discovery, the UE can manually configure the discovery channel from the common channel resources. In these examples, Tx UE 104-a can receive an indication of the discovery channel from the application, and can transmit a cooperation discovery signal over the discovery channel. Similarly, in these examples, Rx UE 104-a can receive the indication of the discovery channel from the application, and can receive a cooperation discovery signal over the discovery channel resources.

In yet another example, the network node or UE cooperation application can use (and/or select) a dedicated resource for UE cooperation discovery. In one example, the network node may transmit a downlink control information (DCI) indicating the dedicated resources (e.g., PSSCH resources) for discovery signals. In either case, for example, Tx UE 104-a can receive an indication of the dedicated discovery channel from the network node or application, and can transmit a cooperation discovery signal over the discovery channel. Similarly, in these examples, Rx UE 104-a can receive the indication of the dedicated discovery channel from the network node or application, and can receive a cooperation discovery signal over the discovery channel resources. For example, using a dedicated resource as opposed to a common channel can reduce the collision as the other transmissions may not be allowed to share the resource; however, this may cause resource consumption. Using dedicated or common resources can be enabled without requiring additional information to indicate the discovery is for UE cooperation (e.g., and not for sidelink) as the information can be carried in PSSCH as normal sidelink discovery signal.

In method 500, optionally at Block 510, an indication of a common channel or a dedicated channel for cooperation discovery can be received from a network node or a cooperating communication application. In an aspect, discovery signal component 352, e.g., in conjunction with processor(s) 312, memory 316, transceiver 302, UE communicating component 342, etc., of the Tx UE 104-a, can receive, from the network node or the cooperating communication application, the indication of the common channel or the dedicated channel for cooperation discovery, as described above. For example, the indication can include resources (e.g., PSSCH resources) over which the cooperation discover signal is to be transmitted (or received). Cooperating component 354, in this example, can accordingly transmit the cooperation discovery signal over the common channel or the dedicated channel.

In method 600, optionally at Block 610, an indication of a common channel or a dedicated channel for cooperation discovery can be received from a network node or a cooperating communication application. In an aspect, discovery signal component 352, e.g., in conjunction with processor(s) 312, memory 316, transceiver 302, UE communicating component 342, etc., of the Rx UE 104-a, can receive, from the network node or the cooperating communication application, the indication of the common channel or the dedicated channel for cooperation discovery, as described above. For example, the indication can include resources (e.g., PSSCH resources) over which the cooperation discover signal is to be transmitted (or received). Cooperating component 354, in this example, can accordingly receive the cooperation discovery signal over the common channel or the dedicated channel.

In an example, the contents of the cooperation discovery signal (e.g., the parameters included in the cooperation discovery signal) may vary in certain scenarios. For example, where the Tx UE 104-a transmitting the cooperation discovery signal is a target UE, the information carried by the cooperation discovery signal may include resource pool configurations for other UEs (or other nodes) to connect to this UE to provide cooperation, a UE capability of receiving cooperation as a target UE, priority of the traffic from the target UE (e.g., as cooperative UE may connect with multiple target UEs, this can help cooperative UE determine an order of providing cooperation to the multiple target UEs), mobility behavior of target UE, requirement for cooperative UE (e.g., if the target UE has such a requirement), etc. In this example, discovery signal component 352 of the Rx UE 104-b can receive the cooperation discovery signal, and cooperating component 354 can determine the resources for connecting to the Tx UE 104-a (e.g., establishing the sidelink connection, as described above), determine the priority for providing cooperation to multiple UEs (e.g., priority for transmitting communications received from the multiple UEs to the network node or for transmitting communications received from the network node to the multiple UEs, etc.).

In another example, where the Tx UE 104-a is a cooperative UE, the information carried by the cooperation discovery signal may include a possible cooperation time (e.g., start and end time of cooperation), a UE capability of providing cooperation as a cooperative UE, etc. In this example, discovery signal component 352 of the Rx UE 104-b can receive the cooperation discovery signal, and cooperating component 354 can determine the time during which the Rx UE 104-b can use the Tx UE 104-a for cooperation, attempt to establish a sidelink connection with the Tx UE 104-a during this time, etc.

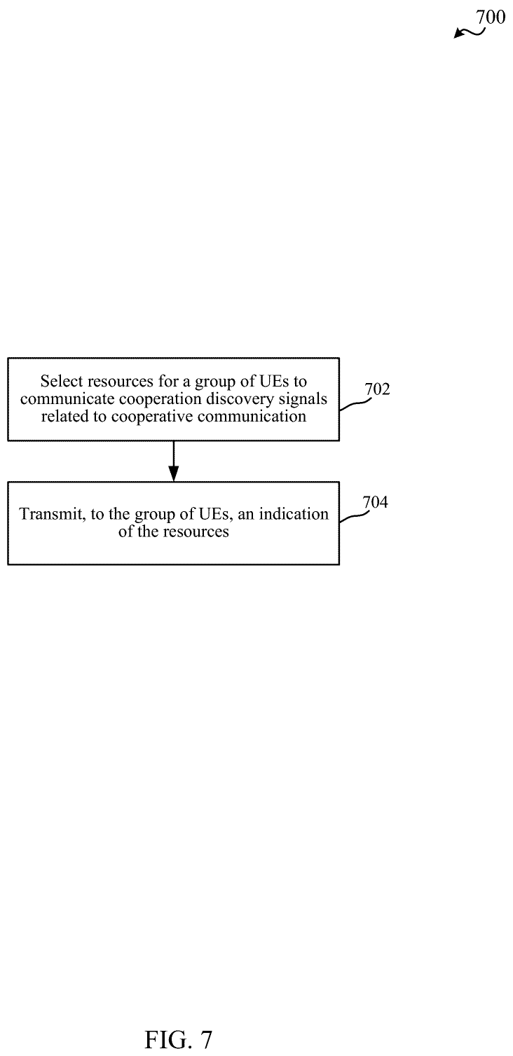

FIG. 7 illustrates a flow chart of an example of a method 700 for configuring resources for a UE to use in transmitting cooperation discovery signals. In an example, a network node (e.g., a base station 102 or gNB, one or more components of a disaggregated base station, such as a CU, DU, RU, etc.) can perform the functions described in method 700 using one or more of the components described in FIGS. 1 and 4.

In method 700, at Block 702, resources can be selected for a group of UEs to communicate cooperation discovery signals related to cooperative communication. In an aspect, configuring component 442, e.g., in conjunction with processor(s) 412, memory 416, transceiver 402, etc., can select the resources for the group of UEs to communicate cooperation discovery signals related to cooperative communication. For example, configuring component 442 can select resources for a common channel common to multiple UEs, or can select resources specific to a given UE for transmitting or receiving cooperation discovery signals.

In method 700, at Block 704, an indication of the resources can be transmitted to the group of UEs. In an aspect, configuring component 442, e.g., in conjunction with processor(s) 412, memory 416, transceiver 402, etc., can transmit the indication of resources to the UEs. For example, configuring component 442 can transmit the indication of resources to the UEs in broadcast signaling (e.g., in a MIB or SIB transmitted over PBCH), in paging signaling to a specific UE, in DCI, etc.

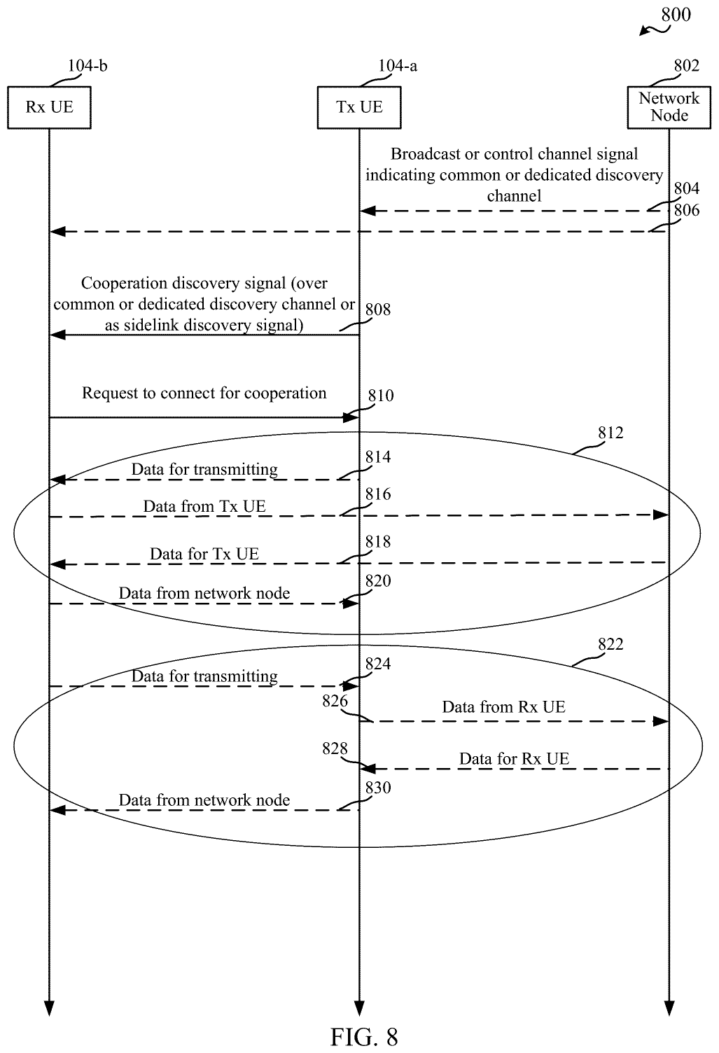

FIG. 8 illustrates an example of a call flow 800 of communications between a Tx UE 104-a, a Rx UE 104-b, and/or a network node 802, in accordance with some aspects described herein. In an example, network node 802 can include a base station 102, which may be a monolithic base station, a disaggregated base station, etc., a disaggregated portion of the base station, such as a CU, DU, or RU, and/or the like, as described above. In addition, various communications between the nodes are shown for illustrative purposes, but may not be required to perform the functions described herein, and in some examples, certain ones of the nodes may also not be required. For example, the Tx UE 104-a and Rx UE 104-b may communicate over sidelink without network node 802.

In one example, network node 802 can transmit broadcast or control channel signal indicating common or dedicated discovery channel for cooperation at 804 and 806, as described. For example, the broadcast signal can be MIB or SIB transmitted over PBCH, a paging signal, etc., or control channel signal can include DCI, and/or the like. Tx UE 104-a and Rx UE 104-b can receive the signal(s). In addition, the signal can indicate a common channel or dedicated channel for receiving or transmitting cooperation discovery signals, as described. In an example, the Tx UE 104-a can transmit, and/or the Rx UE 104-b can receive, a cooperating discovery signal at 808, where the cooperation discovery signal may be over a common or dedicated discovery channel or as a sidelink discovery signal, as described above. For example, the common or dedicated discovery channel can include that indicated by the network node 802 at 804, 806. In another example, the sidelink discovery signal can be modified or otherwise indicated (e.g., in PBSCH, DS-PSCCH) as including parameters for cooperative communication. In any case, Rx UE 104-b can transmit, and/or Tx UE 104-a can receive, a request to connect for cooperation at 810. For example, the request can relate to a request to establish a sidelink communication for cooperative communication. In addition, as described, the request can be transmitted over resources indicated by the cooperation discovery signal, in one example.

Cooperation can be established between the Tx UE 104-a and Rx UE 104-b, where one of the UEs can be a target UE and the other can be a cooperative UE. Where the Tx UE 104-a is the target UE and Rx UE 104-b is the cooperative UE, at 812, various communications are possible. For example, the Tx UE 104-a can transmit, to the Rx UE 104-b), data for transmitting to a network node at 814. The Rx UE 104-b can transmit the data from the Tx UE to the network node 802 at 816, where the data can have been baseband processed by the Tx UE 104-a. In another example, the Rx UE 104-b can receive, from the network node 802, data for the Tx UE at 818. The Rx UE 104-b can transmit the data, from the network node, to Tx UE 104-a at 820 (e.g., without baseband processing the data).

Where the Tx UE 104-a is the cooperative UE and Rx UE 104-b is the target UE, at 822, various communications are possible. For example, the Rx UE 104-b can transmit, to the Tx UE 104-a), data for transmitting to a network node at 824. The Tx UE 104-a can transmit the data from the Rx UE to the network node 802 at 826, where the data can have been baseband processed by the Rx UE 104-b. In another example, the Tx UE 104-a can receive, from the network node 802, data for the Rx UE at 828. The Tx UE 104-a can transmit the data, from the network node, to Rx UE 104-b at 830 (e.g., without baseband processing the data).

FIG. 9 is a block diagram of a MIMO communication system 900 including a base station 102 and a UE 104, in accordance with various aspects of the present disclosure. The MIMO communication system 900 may illustrate aspects of the wireless communication access network 100 described with reference to FIG. 1. The base station 102 may be an example of aspects of the base station 102 described with reference to FIG. 1. In addition, the UE 104 can communicate with another UE over sidelink resources using similar functionality described herein with respect to UE 104 and base station 102 communications, and as such, base station 102 could be another UE 104 having a UE communicating component 342.

The base station 102 may be equipped with antennas 934 and 935, and the UE 104 may be equipped with antennas 952 and 953. In the MIMO communication system 900, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 920 may receive data from a data source. The transmit processor 920 may process the data. The transmit processor 920 may also generate control symbols or reference symbols. A transmit MIMO processor 930 may perform spatial processing (e.g., precoding) on data symbols, control symbols, or reference symbols, if applicable, and may provide output symbol streams to the transmit modulator/demodulators 932 and 933. Each modulator/demodulator 932 through 933 may process a respective output symbol stream (e.g., for OFDM, etc.) to obtain an output sample stream. Each modulator/demodulator 932 through 933 may further process (e.g., convert to analog, amplify, filter, and upconvert) the output sample stream to obtain a DL signal. In one example, DL signals from modulator/demodulators 932 and 933 may be transmitted via the antennas 934 and 935, respectively.

The UE 104 may be an example of aspects of the UEs 104 described with reference to FIGS. 1-2. At the UE 104, the UE antennas 952 and 953 may receive the DL signals from the base station 102 and may provide the received signals to the modulator/demodulators 954 and 955, respectively. Each modulator/demodulator 954 through 955 may condition (e.g., filter, amplify, downconvert, and digitize) a respective received signal to obtain input samples. Each modulator/demodulator 954 through 955 may further process the input samples (e.g., for OFDM, etc.) to obtain received symbols. A MIMO detector 956 may obtain received symbols from the modulator/demodulators 954 and 955, perform MIMO detection on the received symbols, if applicable, and provide detected symbols. A receive (Rx) processor 958 may process (e.g., demodulate, deinterleave, and decode) the detected symbols, providing decoded data for the UE 104 to a data output, and provide decoded control information to a processor 980, or memory 982.

The processor 980 may in some cases execute stored instructions to instantiate a UE communicating component 342 (see e.g., FIGS. 1 and 3). In addition, in an example, UE 104 can be a sidelink transmitting UE, as described herein, and can use the components described herein to communicate with a sidelink receiving UE. In addition, in another example, UE 104 can be a sidelink receiving UE, as described herein, and can use the components described herein to communicate with a sidelink transmitting UE.

On the uplink (UL), at the UE 104, a transmit processor 964 may receive and process data from a data source. The transmit processor 964 may also generate reference symbols for a reference signal. The symbols from the transmit processor 964 may be precoded by a transmit MIMO processor 966 if applicable, further processed by the modulator/demodulators 954 and 955 (e.g., for SC-FDMA, etc.), and be transmitted to the base station 102 in accordance with the communication parameters received from the base station 102. At the base station 102, the UL signals from the UE 104 may be received by the antennas 934 and 935, processed by the modulator/demodulators 932 and 933, detected by a MIMO detector 936 if applicable, and further processed by a receive processor 938. The receive processor 938 may provide decoded data to a data output and to the processor 940 or memory 942.

The processor 940 may in some cases execute stored instructions to instantiate a configuring component 442 (see e.g., FIGS. 1 and 4).

The components of the UE 104 may, individually or collectively, be implemented with one or more application specific integrated circuits (ASICs) adapted to perform some or all of the applicable functions in hardware. Each of the noted modules may be a means for performing one or more functions related to operation of the MIMO communication system 900. Similarly, the components of the base station 102 may, individually or collectively, be implemented with one or more ASICs adapted to perform some or all of the applicable functions in hardware. Each of the noted components may be a means for performing one or more functions related to operation of the MIMO communication system 900.

The following aspects are illustrative only and aspects thereof may be combined with aspects of other embodiments or teaching described herein, without limitation.

Aspect 1 is a method for wireless communication including transmitting, by a first UE, a cooperation discovery signal related to cooperative communication, and receiving, from one or more second UEs and in response to the cooperation discovery signal, a request to connect with the first UE for cooperative communication.

In Aspect 2, the method of Aspect 1 includes where the cooperation discovery signal includes a sidelink discovery channel transmitted, by the first UE, over a sidelink channel.

In Aspect 3, the method of Aspect 2 includes where the cooperation discovery signal includes one or more bits indicating that the cooperation discovery signal is for cooperative communication.

In Aspect 4, the method of any of Aspects 2 or 3 includes transmitting a broadcast signal over a PSBCH, where the broadcast signal includes one or more reserved bits indicating that the cooperation discovery signal is for cooperative communication.

In Aspect 5, the method of any of Aspects 2 to 4 includes transmitting a control signal over a PSCCH, where the control signal includes one or more bits indicating that the cooperation discovery signal is for cooperative communication.

In Aspect 6, the method of any of Aspects 1 to 5 includes where transmitting the cooperation discovery signal includes transmitting the cooperation discovery signal over a common channel in an unlicensed frequency band.

In Aspect 7, the method of Aspect 6 includes where the common channel is common for a specific group of UEs including the first UE and the one or more second UEs.

In Aspect 8, the method of any of Aspects 6 or 7 includes receiving, from a network node, a configuration indicating resources for the common channel.

In Aspect 9, the method of Aspect 8 includes where receiving the configuration includes receiving, from the network node, the configuration in system information signaling.

In Aspect 10, the method of any of Aspects 8 or 9 includes where receiving the configuration includes receiving, from the network node, the configuration in dedicated signaling.

In Aspect 11, the method of any of Aspects 6 to 10 includes where a cooperating communication application executing on the first UE indicates the common channel.

In Aspect 12, the method of Aspect 11 includes where the cooperating communication application receives an indication of the common channel from the one or more second UEs.

In Aspect 13, the method of any of Aspects 1 to 12 includes where transmitting the cooperation discovery signal includes transmitting the cooperation discovery signal over a dedicated channel for cooperation discovery.

In Aspect 14, the method of Aspect 13 includes receiving, from a network node or a cooperating communication application, an indication of the dedicated channel for cooperation discovery.

In Aspect 15, the method of any of Aspects 1 to 14 includes where the first UE is a target UE in the cooperative communication, and where the cooperation discovery signal includes one or more of a resource pool configuration for the one or more second UEs to connect to the target UE, a UE capability of the target UE, a priority of traffic for the cooperative communication, or a mobility behavior of the target UE.

In Aspect 16, the method of any of Aspects 1 to 15 includes where the first UE is a cooperative UE in the cooperative communication, and where the cooperation discovery signal includes one or more of a start time for cooperative communication supported by the first UE, an end time for cooperative communication supported by the first UE, or a UE capability of the cooperative UE.

Aspect 17 is a method for wireless communication includes receiving, from a first UE, a cooperation discovery signal related to cooperative communication, and transmitting, by a second UE and in response to the cooperation discovery signal, a request to connect with the first UE for cooperative communication.

In Aspect 18, the method of Aspect 17 includes where the cooperation discovery signal includes a sidelink discovery channel received, from the first UE, over a sidelink channel.

In Aspect 19, the method of Aspect 18 includes where the cooperation discovery signal includes one or more bits indicating that the cooperation discovery signal is for cooperative communication.

In Aspect 20, the method of any of Aspects 18 or 19 includes receiving a broadcast signal over a PSBCH, where the broadcast signal includes one or more reserved bits indicating that the cooperation discovery signal is for cooperative communication.

In Aspect 21, the method of any of Aspects 18 to 20 includes receiving a control signal over a PSCCH, where the control signal includes one or more bits indicating that the cooperation discovery signal is for cooperative communication.

In Aspect 22, the method of any of Aspects 17 to 21 includes where receiving the cooperation discovery signal includes receiving the cooperation discovery signal over a common channel in an unlicensed frequency band.

In Aspect 23, the method of Aspect 22 includes where the common channel is common for a specific group of UEs including the first UE and the second UE.

In Aspect 24, the method of any of Aspects 22 or 23 includes receiving, from a network node, a configuration indicating resources for the common channel.

In Aspect 25, the method of Aspect 24 includes where receiving the configuration includes receiving, from the network node, the configuration in system information signaling.

In Aspect 26, the method of any of Aspects 24 or 25 includes where receiving the configuration includes receiving, from the network node, the configuration in dedicated signaling.

In Aspect 27, the method of any of Aspects 22 to 26 includes where a cooperating communication application executing on the second UE indicates the common channel.

In Aspect 28, the method of Aspect 27 includes where the cooperating communication application receives an indication of the common channel from the first UE.

In Aspect 29, the method of any of Aspects 17 to 28 includes where receiving the cooperation discovery signal includes receiving the cooperation discovery signal over a dedicated channel for cooperation discovery.

In Aspect 30, the method of Aspect 29 includes receiving, from a network node or a cooperating communication application, an indication of the dedicated channel for cooperation discovery.

In Aspect 31, the method of any of Aspects 17 to 30 includes where the first UE is a target UE in the cooperative communication, and where the cooperation discovery signal includes one or more of a resource pool configuration for the one or more second UEs to connect to the target UE, a UE capability of the target UE, a priority of traffic for the cooperative communication, or a mobility behavior of the target UE.

In Aspect 32, the method of any of Aspects 17 to 31 includes where the first UE is a cooperative UE in the cooperative communication, and where the cooperation discovery signal includes one or more of a start time for cooperative communication supported by the first UE, an end time for cooperative communication supported by the first UE, or a UE capability of the cooperative UE.

Aspect 33 is a method for wireless communication including selecting resources for a group of UEs to communicate cooperation discovery signals related to cooperative communication, and transmitting, to the group of UEs, an indication of the resources.

In Aspect 34, the method of Aspect 33 includes where the resources include a common channel in an unlicensed frequency band.

In Aspect 35, the method of any of Aspects 33 or 34 includes where transmitting the indication includes transmitting, to the group of UEs, the indication in system information signaling.

In Aspect 36, the method of any of Aspects 33 to 35 includes where transmitting the indication includes transmitting, to the group of UEs, the indication in a paging message to each UE in the group of UEs.

Aspect 37 is an apparatus for wireless communication including a transceiver, a memory configured to store instructions, and one or more processors communicatively coupled with the memory and the transceiver, where the one or more processors are configured to execute the instructions to cause the apparatus to perform one or more of the methods of any of Aspects 1 to 36.

Aspect 38 is an apparatus for wireless communication including means for performing one or more of the methods of any of Aspects 1 to 36.

Aspect 39 is a computer-readable medium including code executable by one or more processors for wireless communications, the code including code for performing one or more of the methods of any of Aspects 1 to 36.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, hardwiring, or combinations of any of these. Features implementing functions may also be physically located at various positions, including being distributed such that portions of functions are implemented at different physical locations. Moreover, the term “or” is intended to mean an inclusive “or” rather than an exclusive “or.” That is, unless specified otherwise, or clear from the context, the phrase, for example, “X employs A or B” is intended to mean any of the natural inclusive permutations. That is, for example the phrase “X employs A or B” is satisfied by any of the following instances: X employs A; X employs B; or X employs both A and B. Also, as used herein, including in the claims, “or” as used in a list of items prefaced by “at least one of” indicates a disjunctive list such that, for example, a list of “at least one of A, B, or C” means A or B or C or AB or AC or BC or ABC (A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. A first user equipment (UE) for wireless communication, comprising:
a transceiver;
a memory configured to store instructions; and
one or more processors communicatively coupled with the memory and the transceiver, wherein the one or more processors are configured to:
transmit a cooperation discovery signal related to cooperative communication; and
receiving, from one or more second UEs and in response to the cooperation discovery signal, a request to connect with the first UE for cooperative communication.

2. The first UE of claim 1, wherein the cooperation discovery signal includes a sidelink discovery channel transmitted, by the first UE, over a sidelink channel.

3. The first UE of claim 2, wherein the cooperation discovery signal includes one or more bits indicating that the cooperation discovery signal is for cooperative communication.

4. The first UE of claim 2, wherein the one or more processors are further configured to transmit a broadcast signal over a physical sidelink broadcast channel (PSBCH), wherein the broadcast signal includes one or more reserved bits indicating that the cooperation discovery signal is for cooperative communication.

5. The first UE of claim 2, wherein the one or more processors are further configured to transmit a control signal over a physical sidelink control channel (PSCCH), wherein the control signal includes one or more bits indicating that the cooperation discovery signal is for cooperative communication.

6. The first UE of claim 1, wherein the one or more processors are configured to transmit the cooperation discovery signal over a common channel in an unlicensed frequency band.

7. The first UE of claim 6, wherein the common channel is common for a specific group of UEs including the first UE and the one or more second UEs.

8. The first UE of claim 6, wherein the one or more processors are further configured to receive, from a network node, a configuration indicating resources for the common channel.

9. The first UE of claim 8, wherein the one or more processors are configured to receive, from the network node, the configuration in one of system information signaling or dedicated signaling.

10. The first UE of claim 6, wherein a cooperating communication application executing on the first UE indicates the common channel, and wherein the cooperating communication application receives an indication of the common channel from the one or more second UEs.

11. The first UE of claim 1, wherein the one or more processors are configured to transmit the cooperation discovery signal over a dedicated channel for cooperation discovery, and wherein the one or more processors are further configured to receive, from a network node or a cooperating communication application, an indication of the dedicated channel for cooperation discovery.

12. The first UE of claim 1, wherein the first UE is a target UE in the cooperative communication, and wherein the cooperation discovery signal includes one or more of a resource pool configuration for the one or more second UEs to connect to the target UE, a UE capability of the target UE, a priority of traffic for the cooperative communication, or a mobility behavior of the target UE.

13. The first UE of claim 1, wherein the first UE is a cooperative UE in the cooperative communication, and wherein the cooperation discovery signal includes one or more of a start time for cooperative communication supported by the cooperative UE, an end time for cooperative communication supported by the cooperative UE, or a UE capability of the cooperative UE.

14. A first user equipment (UE) for wireless communication, comprising:
a transceiver;
a memory configured to store instructions; and
one or more processors communicatively coupled with the memory and the transceiver, wherein the one or more processors are configured to:
receive, from a second UE, a cooperation discovery signal related to cooperative communication; and
transmit, in response to the cooperation discovery signal, a request to connect with the second UE for cooperative communication.

15. The first UE of claim 14, wherein the cooperation discovery signal includes a sidelink discovery channel received, from the second UE, over a sidelink channel.

16. The first UE of claim 15, wherein the cooperation discovery signal includes one or more bits indicating that the cooperation discovery signal is for cooperative communication.

17. The first UE of claim 15, wherein the one or more processors are further configured to receive a broadcast signal over a physical sidelink broadcast channel (PSBCH), wherein the broadcast signal includes one or more reserved bits indicating that the cooperation discovery signal is for cooperative communication.

18. The first UE of claim 15, wherein the one or more processors are further configured to receive a control signal over a physical sidelink control channel (PSCCH), wherein the control signal includes one or more bits indicating that the cooperation discovery signal is for cooperative communication.

19. The first UE of claim 14, wherein receiving the cooperation discovery signal includes receiving the cooperation discovery signal over a common channel in an unlicensed frequency band.

20. The first UE of claim 19, wherein the common channel is common for a specific group of UEs including the first UE and the second UE.

21. The first UE of claim 20, wherein the one or more processors are further configured to receive, from a network node, a configuration indicating resources for the common channel.

22. The first UE of claim 21, wherein the one or more processors are configured to receive, from the network node, the configuration in one or more of system information signaling or dedicated signaling.

23. The first UE of claim 19, wherein a cooperating communication application executing on the first UE indicates the common channel, wherein the cooperating communication application receives an indication of the common channel from the second UE.

24. The first UE of claim 14, wherein the one or more processors are configured to receive the cooperation discovery signal over a dedicated channel for cooperation discovery, and wherein the one or more processors are further configured to receive, from a network node or a cooperating communication application, an indication of the dedicated channel for cooperation discovery.

25. The first UE of claim 14, wherein the second UE is a target UE in the cooperative communication, and wherein the cooperation discovery signal includes one or more of a resource pool configuration for the first UE to connect to the target UE, a UE capability of the target UE, a priority of traffic for the cooperative communication, or a mobility behavior of the target UE.

26. The first UE of claim 14, wherein the second UE is a cooperative UE in the cooperative communication, and wherein the cooperation discovery signal includes one or more of a start time for cooperative communication supported by the cooperative UE, an end time for cooperative communication supported by the cooperative UE, or a UE capability of the cooperative UE.

27. A method for wireless communication, comprising:
transmitting, by a first user equipment (UE), a cooperation discovery signal related to cooperative communication; and
receiving, from one or more second UEs and in response to the cooperation discovery signal, a request to connect with the first UE for cooperative communication.

28. The method of claim 27, wherein the cooperation discovery signal includes a sidelink discovery channel transmitted, by the first UE, over a sidelink channel.

29. A method for wireless communication, comprising:
receiving, from a first user equipment (UE), a cooperation discovery signal related to cooperative communication; and
transmitting, by a second UE and in response to the cooperation discovery signal, a request to connect with the first UE for cooperative communication.

30. The method of claim 29, wherein the cooperation discovery signal includes a sidelink discovery channel received, from the first UE, over a sidelink channel.
